(19) United States
(12) Patent Application Publication
(10) Pub. No.: US 2014/0125540 A1
(43) Pub. Date: May 8, 2014

(54) ANTENNA MODULE AND COMMUNICATION DEVICE EQUIPPED THEREWITH

(71) Applicant: Murata Manufacturing Co., Ltd., Nagaokakyo-shi (JP)

(72) Inventors: Hiroyuki TETSUNO, Nagaokakyo-shi (JP); Taro HIRAI, Nagaokakyo-shi (JP)

(73) Assignee: Murata Manufacturing Co., Ltd., Nagaokakyo-shi (JP)

(21) Appl. No.: 14/064,246

(22) Filed: Oct. 28, 2013

(30) Foreign Application Priority Data
Nov. 8, 2012 (JP) 2012-246400

(51) Int. Cl. H01Q 1/50

(52) U.S. Cl. CPC H01Q 1/50
USPC 343/822; 343/860

(57) ABSTRACT

An RF signal input and output to and from a communication unit is extracted to outside of an antenna module before the RF signal is routed through a matching circuit unit and an antenna unit and a variation occurs, and the RF signal is accurately measured and inspected using a high-frequency wave measuring instrument such as a network analyzer. When the characteristics of the antenna unit have fluctuated or been deteriorated after the antenna module has been installed in a communication device, a measure is implemented by connecting an external matching circuit unit or an external antenna unit to a signal extraction unit.

### BACKGROUND OF THE INVENTION

1. Field of the Invention

The present invention relates to an antenna module in which a matching circuit unit is provided between an antenna unit and a communication unit, and a communication device equipped with the antenna module.

2. Description of the Related Art

In the past, in a transmission portion in a communication device, examples of which include a portable communication terminal such as a cellular phone or a portable information terminal, a wireless LAN terminal, and a measuring instrument for a blood pressure, body weight, a blood sugar level, or the like, the measuring instrument having a communication function, an antenna module in which a matching circuit unit is provided between an antenna unit and a communication unit is installed (see, for example, paragraphs [0045] to [0053], FIGS. 6 and 7, and so forth in Japanese Unexamined Patent Application Publication No. 2011-41097). In other words, as illustrated in FIG. 7, an antenna module 500 of the related art includes an antenna unit 501, which includes an antenna element 501a (antenna element) forming a monopole type antenna, and a communication unit 502 where various kinds of circuit elements such as RF-ICs are provided, the RF-ICs processing an RF signal input and output from and to the antenna unit 501, and the RF signal are input and output from and to the antenna unit 501.

In addition, a matching circuit unit 503 including a matching circuit or an attenuator, formed owing to a circuit element such as a capacitor, an inductor, or the like, is provided between the antenna unit 501 and the communication unit 502. In addition, the antenna module 500 is installed in, for example, a communication device performing wireless communication based on Bluetooth (registered trademark) whose band is about 2.4 GHz and that is standardized as IEEE802.15.1, or a communication device performing wireless communication based on a wireless LAN standardized as IEEE802.11. In addition, FIG. 7 is a plan view illustrating an antenna module of the related art.

In the above-mentioned antenna module 500, when the characteristics of the RF signal output from the communication unit 502 are inspected, the inspection is performed by monitoring an antenna power signal after the RF signal output from the communication unit 502 has been routed through the matching circuit unit 503 and the antenna unit 501. However, the antenna power signal greatly varies owing to a tolerance at the time of the formation of the antenna element 501a in the antenna module 500 and an environmental factor such as a surrounding environment. Accordingly, there has been a problem that it is difficult to correctly inspect the characteristics of the RF signal output from the communication unit 502 by monitoring the antenna power signal after the RF signal has been routed through the matching circuit unit 503 and the antenna unit 501.

In addition, in particular, when the antenna element 501a included in the antenna unit 501 forms a monopole type antenna, the characteristics of the antenna unit 501 included in the antenna module 500 are greatly influenced by an external environment such as a grounding state when the antenna module 500 has been installed in the communication device. Accordingly, usually the antenna module 500 is designed so that the antenna unit 501 has predetermined characteristics when the corresponding antenna module 500 has been installed in the communication device. In other words, the antenna module 500 is designed in accordance with an external environment in which the corresponding antenna module 500 is used. However, at the time of the design of the antenna module 500, what communication device the corresponding antenna module 500 is installed in and what external environment the corresponding antenna module 500 is used in are uncertain in some cases. In this case, a circuit element disposed so as to satisfy predetermined characteristics has already been completed with a minimum area in the matching circuit unit 503. Therefore, there has been a problem that even if the characteristics of the antenna unit 501 have fluctuated or been deteriorated when the antenna module 500 has been installed in the communication device, it is difficult to implement a measure to add or change an element after the installation.

### SUMMARY OF THE INVENTION

In view of the above-mentioned problems, preferred embodiments of the present invention provide an antenna module that correctly measures an RF signal input and output to and from a communication unit and implements a measure when the characteristics of an antenna unit have fluctuated or been deteriorated after having been installed in a communication device, and a communication device equipped with the antenna module.

According to a preferred embodiment of the present invention, an antenna module includes a first antenna unit, a communication unit in which an RF signal is input and output to and from the first antenna unit, and a first matching circuit unit provided between the first antenna unit and the communication unit, wherein a signal extraction unit is provided on a signal line connecting the first matching circuit unit and the communication unit.

In the antenna module configured in such a way, since the signal extraction unit is provided on the signal line connecting the first matching circuit unit and the communication unit, the RF signal input and output to and from the communication unit is extracted to the outside of the antenna module before the RF signal is routed through the matching circuit unit and the antenna unit and a variation occurs, and the RF signal can be correctly measured and inspected using a high-frequency wave (RF) measuring instrument such as a network analyzer.

In addition, when the characteristics of the antenna unit have fluctuated after the antenna module has been installed in a communication device, it is possible to implement a measure, for example, by connecting an external matching circuit to the signal extraction unit and adjusting an impedance conversion amount between the antenna unit and the communication unit. In addition, when the characteristics of the antenna unit have been deteriorated after the antenna module has been installed in the communication device, it is be possible to implement a measure, for example, by connecting an external antenna element to the signal extraction unit and causing the RF signal to be input and output between the corresponding antenna element and the communication unit.

In addition, when the characteristics of the antenna unit have fluctuated or been deteriorated after the antenna module has been installed in the communication device, it is possible to implement a measure by connecting the external matching circuit or the external antenna element to the signal extraction unit. Therefore, it may not be necessary to reserve, on the antenna module, a space used to dispose a circuit element that adjusts the circuit characteristics of the antenna module after the antenna module has been installed in the communication device. Accordingly, by omitting the space used to dispose a circuit element that adjusts the circuit characteristics, it is possible to achieve the miniaturization of the antenna module.

According to a preferred embodiment of the present invention, it is desirable that the antenna module further includes a wiring substrate in which the first antenna unit, the communication unit, the first matching circuit unit, and the signal extraction unit are provided, wherein the signal extraction unit includes a connector provided on one main surface of the wiring substrate, and a mounting terminal provided on the other main surface of the wiring substrate.

In a case where such a configuration is adopted, for example, when the antenna module is connector-connected to the communication device, it is possible to extract the RF signal from the connector provided on the one main surface of the wiring substrate. In addition, for example, when the antenna module is surface-mounted in the communication device using a solder or the like, it is possible to extract the RF signal from the mounting terminal provided on the other main surface of the wiring substrate. Accordingly, in accordance with the installation form of the antenna module in the communication device, it is possible to extract the RF signal from one of the connector and the mounting terminal or both thereof. Therefore, it is possible to install the antenna module in the communication device using a plurality of methods, and it is possible to enhance the general versatility of the antenna module.

According to a preferred embodiment of the present invention, it is desirable that the antenna module includes a conduction/non-conduction switching unit configured to connect and disconnect a signal line provided on the corresponding signal line connecting the first matching circuit unit and the signal extraction unit.

When such a configuration is adopted, it is possible to configure a circuit inputting and outputting the RF signal to and from the communication unit in the antenna module using only an external circuit connected to the signal extraction unit, by disconnecting, owing to the conduction/non-conduction switching unit as appropriate, the signal line connecting the signal extraction unit and the first matching circuit unit. Therefore, it is possible to improve the general versatility of the antenna module.

According to a preferred embodiment of the present invention, a communication device including the antenna module includes a second matching circuit unit configured to be connected to the signal extraction unit.

In the communication device configured in such a way, because the second matching circuit unit is connected to the signal extraction unit, it is possible to provide the communication device where the first antenna unit and the communication unit in the antenna module are matched with a high degree of accuracy.

According to a preferred embodiment of the present invention, the communication device may include a second antenna unit configured to be connected to the second matching circuit unit.

When such a configuration is adopted, it is possible for the communication unit in the antenna module to input the RF signal routed through the first antenna unit and input, through the signal extraction unit, the RF signal routed through the second antenna unit. Therefore, it is possible to provide the communication device capable of executing diversity utilizing the first antenna unit and the second antenna unit. In addition, since it is possible to provide the second antenna unit used to execute diversity, not in the antenna module but on a communication device side where it is easy to reserve a disposition space for a circuit element, it is possible to enhance the degree of freedom of the design of the communication device.

According to a preferred embodiment of the present invention, the communication device may include a switch unit configured to be provided on a signal line connecting the second matching circuit unit and the signal extraction unit, a third matching circuit unit configured to be connected to the switch unit, and a third antenna unit configured to be connected to the third matching circuit unit, wherein the switch unit connects one of the second matching circuit unit and the third matching circuit unit to the signal extraction unit in a switching manner.

When such a configuration is adopted, it is possible to connect, in a switching manner, one of the second antenna unit and the third antenna unit, disposed on the outside of the antenna module, to the signal extraction unit in the antenna module owing to the switch unit.

According to a preferred embodiment of the present invention, it is desirable that the antenna module includes a signal detection unit configured to detect a signal, and a signal detecting terminal configured to be connected to the signal detection unit, and the switch unit includes an extraction terminal configured to extract a signal of the second matching circuit unit or the third matching circuit unit, wherein the signal detecting terminal and the extraction terminal are connected, and the switch unit is switching-controlled on the basis of a detection state of the signal due to the signal detection unit.

When such a configuration is adopted, the signals of the second matching circuit unit and the third matching circuit unit are extracted from the extraction terminal, and input from the signal detecting terminal of the antenna module to the signal detection unit, and the switch unit is switching-controlled on the basis of the detection state of the signal due to the signal detection unit. Accordingly, it is possible to connect one of the second matching circuit unit and the third matching circuit unit, whose signal is more adequately processed, to the signal extraction unit and connect the one to the communication unit in the antenna module.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a block diagram illustrating a first preferred embodiment of a communication device according to the present invention.

FIG. 2 is a plan view illustrating an antenna module installed in a communication device in FIG. 1.

FIG. 3 is a side cross-sectional view of the antenna module in FIG. 2.

FIG. 4 is a diagram illustrating an example of an inspection method for the antenna module in FIG. 2.

FIG. 5 is a block diagram illustrating a second preferred embodiment of a communication device according to the present invention.

FIG. 6 is a block diagram illustrating a third preferred embodiment of a communication device of the present invention.

FIG. 7 is a plan view illustrating an antenna module of the related art.

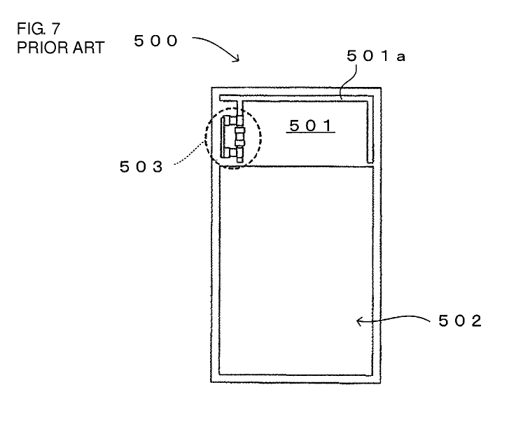

### DETAILED DESCRIPTION OF THE PREFERRED EMBODIMENTS

### First Preferred Embodiment

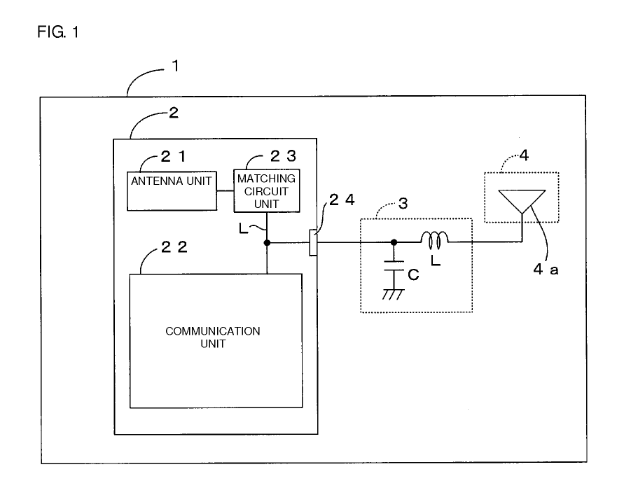

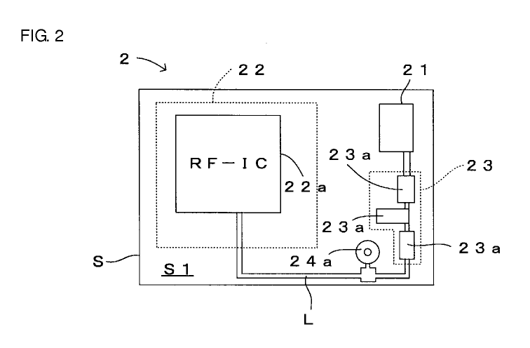

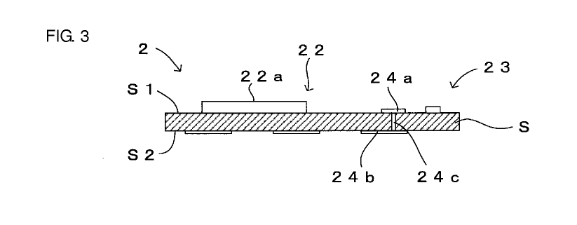

A first preferred embodiment of a communication device according to the present invention will be described with reference to FIG. 1 to FIG. 3. FIG. 1 is a block diagram illustrating the first preferred embodiment of the communication device according to the present invention, FIG. 2 is a plan view illustrating an antenna module installed in a communication device in FIG. 1, and FIG. 3 is the side cross-sectional view of the antenna module in FIG. 2.

A communication device 1 illustrated in FIG. 1 configures a portable communication terminal such as a cellular phone or a portable information terminal, a wireless LAN terminal, or a measuring instrument for a blood pressure, body weight, a blood sugar level, or the like, the measuring instrument having a communication function, and the communication device 1 includes an antenna module 2, a matching circuit unit 3, and an antenna unit 4.

The antenna module 2 includes a wiring substrate S that preferably is a ceramic substrate, a glass epoxy resin substrate, a flexible substrate made of a polyimide resin, or the like, for example. In addition, an antenna unit 21, a communication unit in which an RF signal is input and output to and from the antenna unit 21, and a matching circuit unit 23 provided between the antenna unit 21 and the communication unit 22 are provided on the wiring substrate S. In addition, a signal line L connecting the antenna unit 21, the communication unit 22, and the matching circuit unit 23 is provided on the wiring substrate S, and a signal extraction unit 24 is provided on the signal line L connecting the matching circuit unit 23 and the communication unit 22 in the antenna module 2.

The antenna unit 21 (corresponding to a “first antenna unit” according to a preferred embodiment of the present invention) is provided on one main surface S1 of the wiring substrate S, and includes an antenna element (the illustration thereof is omitted) that is preferably a monopole type or a dipole type in accordance with the intended use of the communication device 1. The communication unit 22 includes an RF-IC 22a processing the RF signal input and output to and from the antenna unit 21, and the RF-IC 22a is surface-mounted on the one main surface S1 of the wiring substrate S.

The matching circuit unit 23 (corresponding to a “first matching circuit unit” according to a preferred embodiment of the present invention) includes a matching circuit including circuit elements 23a such as an inductor and a capacitor being provided on the one main surface S1 of the wiring substrate S. The signal extraction unit 24 is provided on the one main surface S1 of the wiring substrate S, and includes a RF connector 24a provided on the signal line L connecting the matching circuit unit 23 and the communication unit 22, and a mounting terminal 24b provided on the other main surface S2 of the wiring substrate S. In addition, the connector 24a and the mounting terminal 24b are connected by a via conductor 24c.

In addition, while, in this preferred embodiment, the signal extraction unit 24 preferably includes the connector 24a and the mounting terminal 24b, the signal extraction unit 24 may also be configured by only one of the connector 24a and the mounting terminal 24b being provided on the wiring substrate S in accordance with the intended use of the antenna module 2. In addition, in this preferred embodiment, a land grid array (LGA) is preferably provided on the other main surface S2 of the wiring substrate S so that the antenna module 2 is able to be surface-mounted in a mother substrate included in the communication device 1, and the mounting terminal 24b is defined by one electrode included in the LGA.

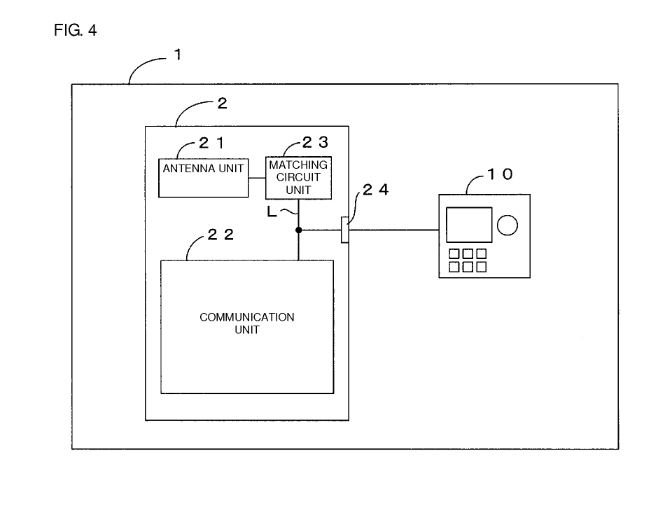

In the antenna module 2 configured in such a way as described above, the signal extraction unit 24 is provided on the signal line L connecting the matching circuit unit 23 and the communication unit 22. Accordingly, as illustrated in an example of an inspection method in FIG. 4, used for the antenna module 2, the RF signal input and output to and from the communication unit 22 is extracted to the outside of the antenna module 2 before the RF signal is routed through the matching circuit unit 23 and the antenna unit 21 and a variation occurs, in a state where the antenna module 2 is installed in the communication device 1, and it is possible to correctly measure and inspect the RF signal by using a high-frequency wave (RF) measuring instrument 10 such as a network analyzer.

Therefore, when the characteristics of the antenna unit 21 have fluctuated after the antenna module 2 has been installed in the communication device 1, it is possible to implement a measure, for example, by connecting the external matching circuit unit 3 to the signal extraction unit 24 and adjusting an impedance conversion amount between the antenna unit 21 and the communication unit 22. In addition, when the characteristics of the antenna unit 21 have been deteriorated after the antenna module 2 has been installed in the communication device 1, it is possible to implement a measure, for example, by connecting the external antenna unit 4 (antenna element 4a) to the signal extraction unit 24 and causing the RF signal to be input and output between the corresponding antenna unit 4 and the communication unit 22.

In addition, when the characteristics of the antenna unit 21 have fluctuated or been deteriorated after the antenna module 2 has been installed in the communication device 1, it is possible to implement a measure by connecting the external matching circuit unit 3 or the external antenna unit 4 to the signal extraction unit 24. Therefore, it may not be necessary to reserve, on the antenna module 2, a space used to dispose a circuit element or the like to adjust the circuit characteristics of the antenna module 2. Accordingly, by omitting the space used to dispose a circuit element that adjusts the circuit characteristics, it is possible to achieve the miniaturization of the antenna module 2.

In addition, the signal extraction unit 24 includes the connector 24a provided on the one main surface S1 of the wiring substrate S and the mounting terminal 24b provided on the other main surface S2 of the wiring substrate S. Therefore, for example, when the antenna module 2 is connector-connected to the communication device 1, it is possible to extract the RF signal from the connector 24a provided on the one main surface S1 of the wiring substrate S. In addition, for example, when the antenna module 2 is surface-mounted in the communication device 1 using a solder or the like, it is possible to extract the RF signal from the mounting terminal 24b provided on the other main surface S2 of the wiring substrate S. Accordingly, in accordance with the installation form of the antenna module 2 in the communication device 1, it is possible to extract the RF signal from one of the connector 24a and the mounting terminal 24b or both thereof. Therefore, it is possible to install the antenna module 2 in the communication device 1 using a plurality of methods, and it is possible to enhance the general versatility of the antenna module 2.

In addition, in a state where the antenna module 2 is not installed in the communication device 1, the RF signal input and output to and from the communication unit 22 is extracted to the outside of the antenna module 2 before the RF signal is routed through the matching circuit unit 23 and the antenna unit 21 and a variation occurs, and it is also possible to correctly measure and inspect the RF signal by using the RF measuring instrument 10.

The matching circuit unit 3 (corresponding to a “second matching circuit unit” according to a preferred embodiment of the present invention) includes a matching circuit preferably of a low-pass type including, for example, an inductor L and a capacitor C, and is connected to the signal extraction unit 24 in the antenna module 2. In addition, in accordance with the installation form of the antenna module 2 in the communication device 1, the matching circuit unit 3 is connected to one of the connector 24a and the mounting terminal 24b of the signal extraction unit 24.

In this preferred embodiment, the antenna unit 4 (corresponding to a “second antenna unit” according to a preferred embodiment of the present invention) includes the antenna element 4a having substantially the same configuration as the antenna element included in the antenna unit 21 installed in the antenna module 2, and is connected to the matching circuit unit 3.

As described above, in the above-mentioned preferred embodiment, because of the matching circuit unit 3 connected to the signal extraction unit 24, it is possible to provide the communication device 1 in which the antenna unit 21 and the communication unit 22 in the antenna module 2 are matched with a high degree of accuracy.

In addition, since the antenna unit 4 is connected to the matching circuit unit 3, it is possible for the communication unit 22 in the antenna module 2 to input the RF signal routed through the antenna unit 21 and input, through the signal extraction unit 24, the RF signal routed through the antenna unit 4. Accordingly, it is possible to provide the communication device 1 capable of executing diversity utilizing the antenna unit 21 and the antenna unit 4. In addition, since it is possible to provide the antenna unit 4 used to execute diversity, not in the antenna module 2 but on a communication device 1 side where it is easy to reserve a disposition space for a circuit element or the like, it is possible to enhance the degree of freedom of the design of the communication device 1.

In addition, if the antenna unit 4 is not necessary, a configuration may also be adopted where only the matching circuit unit 3 is connected to the signal extraction unit 24.

### Second Preferred Embodiment

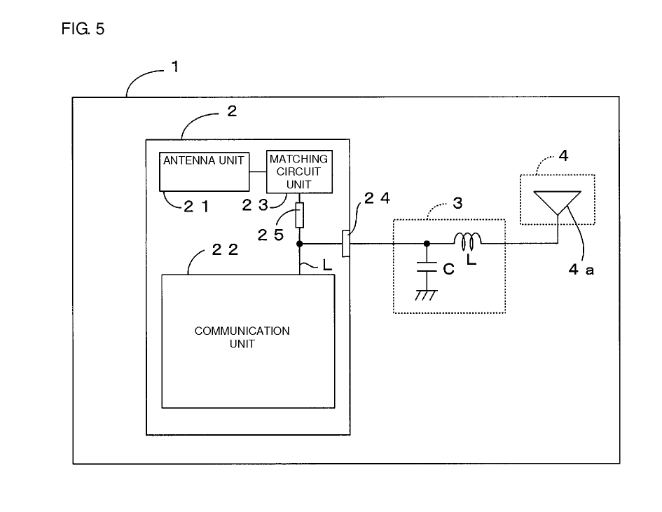

A second preferred embodiment of the communication device of the present invention will be described with reference to FIG. 5. FIG. 5 is a block diagram illustrating the second preferred embodiment of a communication device according to the present invention. This preferred embodiment is different from the above-mentioned first preferred embodiment in that, as illustrated in FIG. 5, the antenna module 2 includes a conduction/non-conduction switching unit 25 that connects and disconnects the signal line L provided on the corresponding signal line L connecting the matching circuit unit 23 and the signal extraction unit 24. In this preferred embodiment, the conduction/non-conduction switching unit 25 includes a jumper chip (the illustration thereof is omitted), and is capable of switching between the connection and disconnection states of the signal line L connecting the matching circuit unit 23 and the signal extraction unit 24, by attaching or detaching the jumper chip. Since the other configuration preferably is substantially the same as in the above-mentioned first preferred embodiment, the same symbols are assigned to substantially the same elements and configuration as in the above-mentioned first preferred embodiment, and the description of such elements and configuration will be omitted.

As described above, in the present preferred embodiment, it is possible to achieve substantially the same advantageous effect as in the above-mentioned first preferred embodiment, and it is possible to achieve the following advantageous effects. In other words, by disconnecting, using the conduction/non-conduction switching unit 25 as appropriate, the signal line L connecting the signal extraction unit 24 and the matching circuit unit 23, it is possible to configure a circuit inputting and outputting the RF signal to and from the communication unit 22 in the antenna module 2 using only an external circuit (the matching circuit unit 3 and the antenna unit 4) connected to the signal extraction unit 24, without using the antenna unit 21 and the matching circuit unit 23, installed in the antenna module 2. Therefore, it is possible to improve the general versatility of the antenna module 2.

In addition, the conduction/non-conduction switching unit 25 is preferably configured so that switching between the connection and disconnection states of the signal line L connecting the matching circuit unit 23 and the signal extraction unit 24 is performed using various kinds of switches provided on the signal line L.

### Third Preferred Embodiment

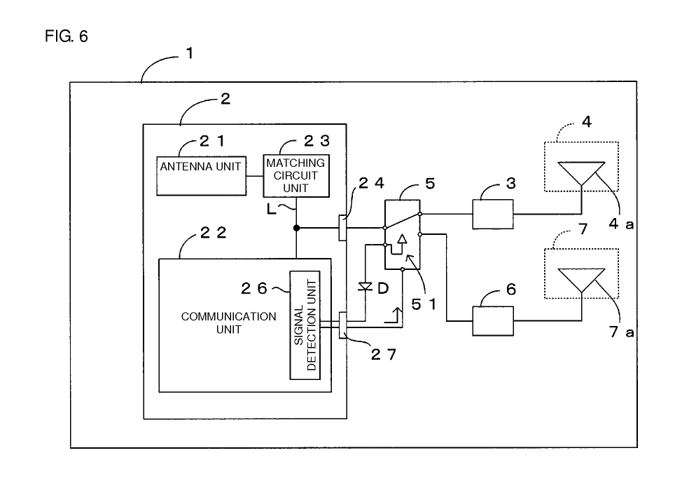

A third preferred embodiment of the communication device of the present invention will be described with reference to FIG. 6. FIG. 6 is a block diagram illustrating the third preferred embodiment of the communication device of the present invention. This preferred embodiment is different from the above-mentioned first preferred embodiment in that, as illustrated in FIG. 6, a switch unit 5 is provided on a signal line connecting the matching circuit unit 3 and the signal extraction unit 24, a matching circuit unit 6 (corresponding to a “third matching circuit unit” according to a preferred embodiment of the present invention) is connected to the switch unit 5, and an antenna unit 7 (corresponding to a “third antenna unit” according to a preferred embodiment of the present invention) including an antenna element 7a is connected to the matching circuit unit 6. In addition, one of the matching circuit unit 3 (the antenna unit 4) and the matching circuit unit 6 (the antenna unit 7) is connected to the signal extraction unit 24 in a switching manner by the switch unit 5.

In addition, as illustrated in FIG. 6, the antenna module 2 includes a signal detection unit 26 detecting an RF signal, and a signal detecting terminal 27 connected to the signal detection unit 26, and the switch unit 5 includes a coupler 51 (corresponding to an “extraction terminal” according to a preferred embodiment of the present invention) extracting the RF signals of the matching circuit unit 3 and the matching circuit unit 6. In addition, the signal detecting terminal 27 and the coupler 51 are connected through a rectifying element D. In addition, as illustrated by an arrow in the drawing, a control signal is output from the signal detecting terminal 27 to the switch unit 5 on the basis of the detection state of the RF signal, due to the signal detection unit 26, and hence, the switch unit 5 is switching-controlled. Since the other configuration preferably is substantially the same as in the above-mentioned first preferred embodiment, the same symbols are assigned to substantially the same elements and configurations as in the above-mentioned first preferred embodiment, and the description of such elements and configurations will be omitted.

As described above, in the present preferred embodiment, it is also possible to achieve substantially the same advantageous effect as in the above-mentioned first preferred embodiment, and it is possible to achieve the following advantageous effect. In other words, it is possible to connect, in a switching manner, one of the antenna unit 4 (the matching circuit unit 3) and the antenna unit 7 (the matching circuit unit 6), disposed on the outside of the antenna module 2, to the signal extraction unit 24 in the antenna module 2 because of the switch unit 5.

In addition, the RF signals of the antenna unit 4 (the matching circuit unit 3) and the antenna unit 7 (the matching circuit unit 6) are extracted by the coupler 51, and input from the signal detecting terminal 27 to the signal detection unit 26 in the antenna module 2. In addition, the switch unit 5 is switching-controlled on the basis of the detection state of the RF signal, due to the signal detection unit 26, and hence, it is possible to connect one of the antenna unit 4 (the matching circuit unit 3) and the antenna unit 7 (the matching circuit unit 6), whose signal is more adequately processed, to the signal extraction unit 24 and connect the one to the communication unit 22 in the antenna module 2.

In addition, one of the RF signals of the antenna unit (the matching circuit unit 3) and the antenna unit 7 (the matching circuit unit 6) is also extracted by the coupler 51.

In addition, the present invention is not limited to the above-mentioned preferred embodiments, the above-mentioned preferred embodiments may also be combined in an arbitrary way without departing from the scope of the present invention, and various modifications may be made in addition to the above-mentioned preferred embodiments. For example, as for the configuration of an antenna element included in each antenna unit, the antenna element may be configured so as to have an optimum shape and an optimum size in accordance with a frequency band or a communication method, used for communication in the communication device 1. In addition, a matching circuit included in each matching circuit unit may also have an optimum configuration in accordance with the configurations of an antenna unit and a communication unit.

In addition, while, in the above-mentioned preferred embodiments, a configuration preferably is adopted where one of the antenna unit 4 and the antenna unit 7 is connected to the signal extraction unit 24 in a switching manner by the switch unit 5, a configuration may also be adopted where one of three or more antenna units provided in the communication device 1 is connected to the signal extraction unit 24 in a switching manner. In addition, the configuration of the communication unit 22 is not limited to the above-mentioned examples, and the communication unit 22 may be configured by selecting an optimum electronic component in accordance with the intended use of the antenna module 2 and mounting the optimum electronic component in the wiring substrate S. For example, an interstage filter (SAW filter), a switch, a multiplexer such as a diplexer, a coupler, or the like may also be further mounted in the communication unit 22.

In addition, various preferred embodiments of the present invention may be widely applied to an antenna module in which a matching circuit unit is provided between an antenna unit and a communication unit, and a communication device equipped with the antenna module.

While preferred embodiments of the invention have been described above, it is to be understood that variations and modifications will be apparent to those skilled in the art without departing from the scope and spirit of the invention. The scope of the invention, therefore, is to be determined solely by the following claims.

1. (canceled)

2. An antenna module comprising:
a first antenna unit;
a communication unit in which an RF signal is input and output to and from the first antenna unit; and
a first matching circuit unit provided between the first antenna unit and the communication unit; wherein
a signal extraction unit is provided on a signal line connecting the first matching circuit unit and the communication unit.

3. The antenna module according to claim 2, further comprising:
a wiring substrate on which the first antenna unit, the communication unit, the first matching circuit unit, and the signal extraction unit are provided; wherein
the signal extraction unit includes a connector provided on one main surface of the wiring substrate, and a mounting terminal provided on the other main surface of the wiring substrate.

4. The antenna module according to claim 2, further comprising a conduction/non-conduction switching unit arranged to connect and disconnect a signal line provided on a signal line connecting the first matching circuit unit and the signal extraction unit.

5. The antenna module according to claim 2, wherein the first antenna unit includes an antenna element that is one of a monopole antenna and a dipole antenna.

6. The antenna module according to claim 2, wherein the communication unit includes an RF-IC arranged to process the RF signal.

7. The antenna module according to claim 2, wherein the first matching circuit includes an inductor and a capacitor.

8. The antenna module according to claim 3, further comprising a via conductor arranged to connect the connector and the mounting terminal.

9. The antenna module according to claim 2, further comprising:
a wiring substrate on which the first antenna unit, the communication unit, the first matching circuit unit, and the signal extraction unit are provided; wherein
the signal extraction unit includes only one of a connector provided on one main surface of the wiring substrate, and a mounting terminal provided on the other main surface of the wiring substrate.

10. The antenna module according to claim 3, further comprising a land grid array provided on the other main surface of the wiring substrate.

11. A communication device including the antenna module according to claim 2, further comprising a second matching circuit unit connected to the signal extraction unit.

12. The communication device according to claim 11, further comprising a second antenna unit connected to the second matching circuit unit.

13. The communication device according to claim 12, further comprising:
a switch unit provided on a signal line connecting the second matching circuit unit and the signal extraction unit;
a third matching circuit unit connected to the switch unit; and
a third antenna unit connected to the third matching circuit unit; wherein
the switch unit connects one of the second matching circuit unit and the third matching circuit unit to the signal extraction unit in a switching manner.

14. The communication device according to claim 13, wherein the antenna module includes:
a signal detection unit arranged to detect a signal; and
a signal detecting terminal connected to the signal detection unit; and
the switch unit includes:
an extraction terminal arranged to extract a signal of the second matching circuit unit or the third matching circuit unit; wherein
the signal detecting terminal and the extraction terminal are connected, and the switch unit is switching-controlled based on a detection state of the signal due to the signal detection unit.

15. The communication device according to claim 11, wherein the communication device is one of a portable communication terminal, a cellular phone, a portable information terminal, a wireless LAN terminal, and a measuring instrument for a blood pressure, body weight, a blood sugar level.

16. The communication device according to claim 11, further comprising a plurality of antenna units in addition to the first antenna unit that are connected to the signal extraction unit in a switching manner by a switch unit.
